(19) United States
(12) Patent Application Publication
(10) Pub. No.: US 2025/0021042 A1
(43) Pub. Date: Jan. 16, 2025

(54) HINGE DEVICE AND IMAGE FORMING APPARATUS EQUIPPED WITH GREASE SWEEPER ABUTTING ON SURFACE OF STATIONARY SUPPORT MEMBER WHEN PIVOTAL SUPPORT MEMBER PIVOTALLY MOVES

(71) Applicant: KYOCERA Document Solutions Inc., Osaka (JP)

(72) Inventor: Chi Thi TRAN, Osaka (JP)

(73) Assignee: KYOCERA Document Solutions Inc., Osaka (JP)

(21) Appl. No.: 18/768,164

(22) Filed: Jul. 10, 2024

(30) Foreign Application Priority Data
Jul. 13, 2023 (JP) 2023-114931

(51) Int. Cl. G03G 21/00

(52) U.S. Cl. CPC G03G 21/0005; G03G 2221/0089

(57) ABSTRACT

A hinge device supports a document holder to allow the document holder to open and close with respect to a body of an image forming apparatus. The hinge device includes a stationary support member, a pivotal support member, and a grease sweeper. The stationary support member is provided on the body of the image forming apparatus. The pivotal support member is provided on the document holder and pivotally connected through a pivotal shaft to the stationary support member. The grease sweeper is attached to the pivotal support member. A distal end of the grease sweeper always abuts on a surface of the stationary support member while the pivotal support member pivotally moves.

### INCORPORATION BY REFERENCE

This application claims priority to Japanese Patent Application No. 2023-114931 filed on 13 Jul. 2023, the entire contents of which are incorporated by reference herein.

### BACKGROUND

The present disclosure relates to hinge devices and image forming apparatuses.

An image forming apparatus, such as a printer, a scanner, a copier or a multifunction peripheral, is equipped with an automatic document conveying device. The automatic document conveying device is mounted by a hinge device to a body of the image forming apparatus pivotally between a closed position where it covers the top surface of the body of the image forming apparatus and an open position where it opens the top surface of the body of the image forming apparatus. In a general image forming apparatus, the top surface of the body of the image forming apparatus is formed of an original glass plate on which an original document to be read is placed. The use of the original glass plate for copying or scanning is a principal feature of the image forming apparatus and, therefore, the hinge device is desired to have a structure capable of stably and smoothly opening and closing the automatic document conveying device.

There is generally known a hinge mechanism for a document conveying device capable of always stably opening and closing the document conveying device. The general hinge mechanism is composed of a plurality of hinge elements. Each hinge element includes: a leg inserted and supported in a support hole formed in a rear end portion of the body of the image forming apparatus; a stationary support frame provided at the top end of the leg; and a pivotal support frame pivotally connected through a pivotal shaft to the stationary support frame. In at least one of the plurality of hinge elements, the stationary support frame and the leg are integrally formed of a single steel plate by bending the single steel plate. Thus, the opening and closing operation of the document conveying device can be always stably performed.

### SUMMARY

A technique improved over the aforementioned technique is proposed as one aspect of the present disclosure.

A hinge device according to an aspect of the present disclosure supports a document holder to allow the document holder to open and close with respect to a body of an image forming apparatus. The hinge device includes a stationary support member, a pivotal support member, and a grease sweeper. The stationary support member is provided on the body of the image forming apparatus. The pivotal support member is provided on the document holder and pivotally connected through a pivotal shaft to the stationary support member. The grease sweeper is attached to the pivotal support member. A distal end of the grease sweeper always abuts on a surface of the stationary support member while the pivotal support member pivotally moves.

An image forming apparatus according to another aspect of the present disclosure includes the above-described hinge device and an image forming device. The image forming device forms an image on a sheet.

### BRIEF DESCRIPTION OF THE DRAWINGS

FIG. 1 is a front view showing an internal structure of an image forming apparatus.

FIG. 2 is a perspective view showing the image forming apparatus with a hinge device.

FIG. 3 is an enlarged view of the portion III of the hinge device in FIG. 2.

FIG. 4 is a vertical cross-sectional view of the hinge device.

FIG. 5 is a vertical cross-sectional view of the hinge device.

### DETAILED DESCRIPTION

Hereinafter, a description will be given of an embodiment of the present disclosure with reference to the drawings. Throughout the drawings, the same or equivalent parts and components are designated by the same reference characters and further description is omitted.

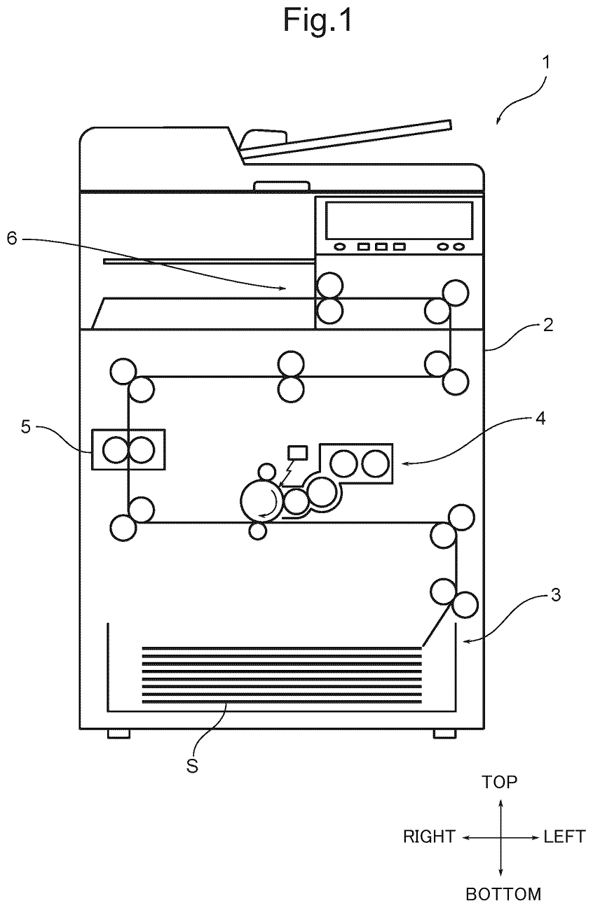

First, referring to FIG. 1, an image forming apparatus 1 according to this embodiment will be described. FIG. 1 is a front view showing an internal structure of the image forming apparatus 1. Hereinafter, as shown in FIG. 1, the top-to-bottom direction of the image forming apparatus 1 when placed in a general state of use is defined as the top-to-bottom direction herein, and the front-to-rear direction herein is defined by assuming the side where a user stands facing the image forming apparatus 1 to be the front side of the image forming apparatus 1. Furthermore, the direction orthogonal to the top-to-down direction and the front-to-rear direction is defined as the right-to-left direction herein.

The image forming apparatus 1 is an apparatus that forms an image. As shown in FIG. 1, the image forming apparatus 1 has a body 2 in an approximately box shape and the body 2 is internally provided with a sheet feed device 3, an image forming device 4, a fixing device 5, a sheet ejection device 6, and a control device.

The sheet feed device 3 accommodates sheets S, picks up the accommodated sheets S sheet by sheet, and feeds the picked sheet S to the image forming device 4. The image forming device 4 forms an image on the sheet S by toner. The fixing device 5 fixes the toner image developed on the sheet S. The sheet ejection device 6 ejects the sheet S with the image formed by the image forming device 4 to the outside. The control device controls the operation of the image forming apparatus 1.

The image forming apparatus 1 is, for example, a printer, a scanner, a copier or a multifunction peripheral.

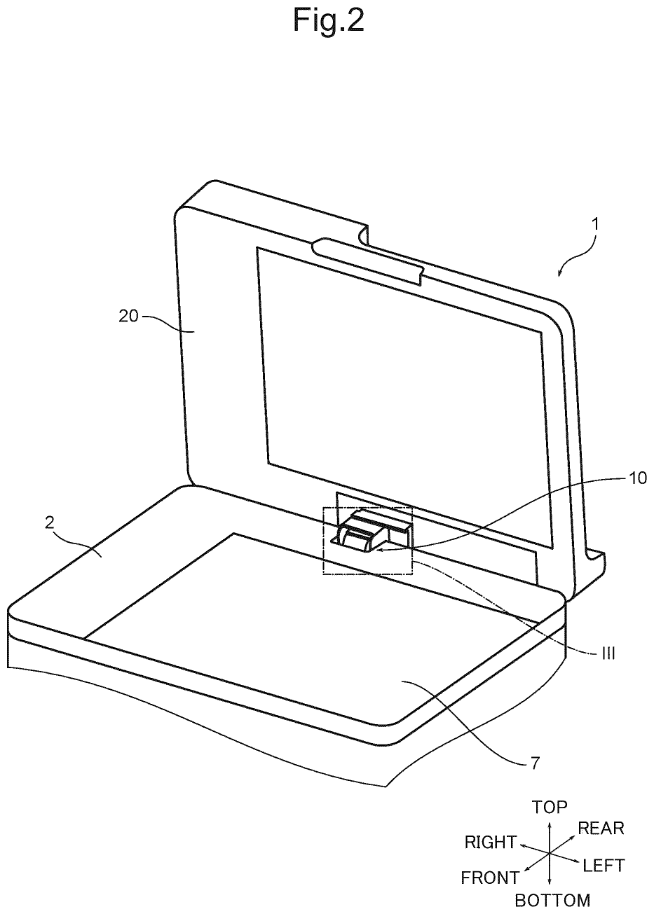

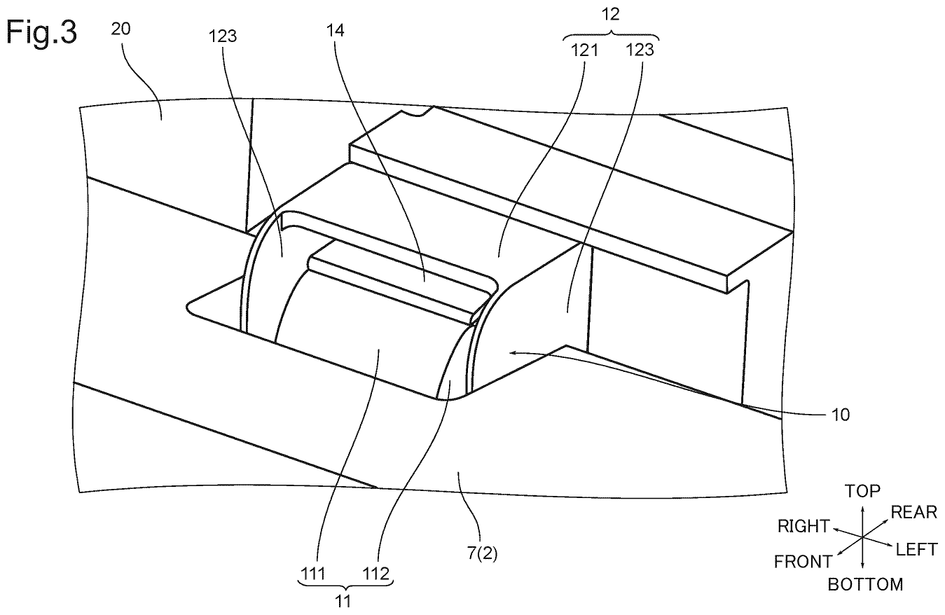

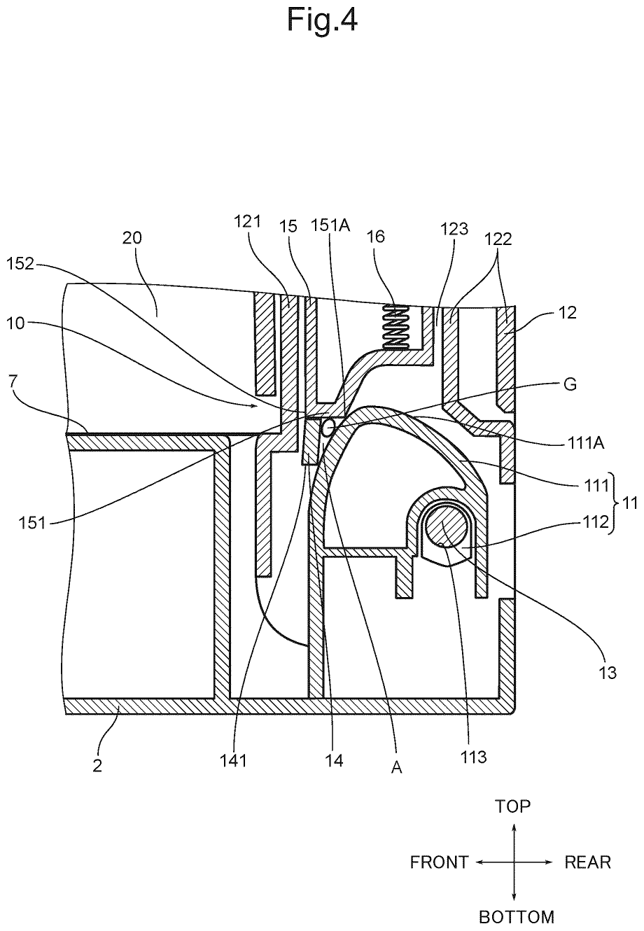

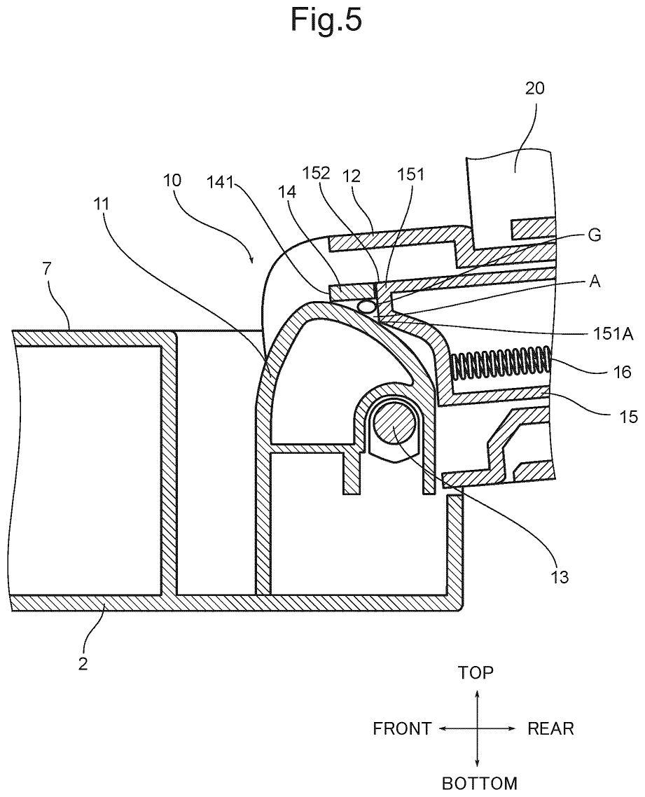

Next, a description will be given of the hinge device 10 according to this embodiment with reference to FIGS. 2 to 5. FIG. 2 is a perspective view showing the image forming apparatus 1 with the hinge device 10. FIG. 3 is an enlarged view of the portion III of the hinge device 10 in FIG. 2. FIGS. 4 and 5 are vertical cross-sectional views of the hinge device 10. FIG. 4 shows a state where a document holder 20 is closed, while FIG. 5 shows a state where the document holder 20 is opened. The vertical cross-sectional view herein refers to a cross-sectional view of an object taken along a vertical plane along the front-to-rear direction.

As shown in FIG. 2, the top surface of the body 2 of the image forming apparatus 1 is formed of an original glass plate 7 on which an original document to be copied or scanned by the image forming apparatus 1 is to be placed. The image forming apparatus 1 includes a document holder 20 that holds an original document placed on the original glass plate 7 when copying or scanning the original document.

The document holder 20 is formed to cover the top surface of the body 2 of the image forming apparatus 1. The document holder 20 is, for example, a document cover or an automatic document conveying device. The document cover and the automatic document conveying device have a known arbitrary structure.

The hinge device 10 is a device that supports the document holder 20 to allow the document holder 20 to open and close with respect to the body 2 of the image forming apparatus 1. The hinge device 10 is provided at the rear ends of the body 2 of the image forming apparatus 1 and the document holder 20.

As shown in FIGS. 3 to 5, the hinge device 10 includes a stationary support member 11, a pivotal support member 12, a pivotal shaft 13, and a grease sweeper 14.

The stationary support member 11 is provided at the rear end of the body 2 of the image forming apparatus 1. The stationary support member 11 includes a surface plate 111 and a pair of side plates 112 that cover both sides of the surface plate 111. The surface plate 111 and the side plates 112 are each formed of a plate-like member.

The surface plate 111 is formed with a plate-like member bent from the front to the rear thereof into an approximately inverted U-shape as viewed from laterally (as viewed from the right or left, as viewed in FIG. 4 or as viewed in FIG. 5). The pair of side plates 112 have a size to cover respective U-shaped openings formed on the right and left sides of the surface plate 111.

The pair of side plates 112 have respective through holes 113 formed therein to allow the pivotal shaft 13 to pass through the through holes 113. The through holes 113 are provided with respective bearings.

The stationary support member 11 is provided on the body 2 of the image forming apparatus 1 in a state where an open end of the approximately U-shape thereof faces downward, the surface plate 111 extends from the front to the rear, and the pair of side plates 112 are arranged in the right-to-left direction.

The pivotal support member 12 is provided on the document holder 20 and pivotally connected through the pivotal shaft 13 to the stationary support member 11. The pivotal support member 12 allows the document holder 20 to pivotally move between a closed position (the position shown in FIG. 4) where the document holder 20 covers the top surface of the body 2 of the image forming apparatus 1 and an open position (the position shown in FIG. 5) where the document holder 20 opens the top surface of the body 2 to the outside.

The pivotal support member 12 is composed of a front plate 121, a back plate 122 opposed to the front plate 121, a pair of side plates 123 covering between the front plate 121 and the back plate 122 from both lateral sides, and a top plate and has an approximately box shape in which one end surface is open. The front plate 121, the back plate 122, the side plates 123, and the top plate are each formed of a plate-like member.

Each of the front plate 121 and the back plate 122 has a length in a widthwise direction (the right-to-left direction) larger than the length of the surface plate 111 of the stationary support member 11 in the widthwise direction (the right-to-left direction). The front plate 121 is provided on the document holder 20 to form the front surface of the pivotal support member 12 when the document holder 20 is in the closed position. At this time, the pair of side plates 123 form the right and left surfaces of the pivotal support member 12 and the top plate forms the top surface of the pivotal support member 12. In other words, when the document holder 20 is in the closed position, the lower surface of the pivotal support member 12 is open.

The pivotal support member 12 includes: a slide member 15 capable of sliding toward and away from the stationary support member 11; and a spring member 16 that biases the slide member 15 toward moving the slide member 15 close to the stationary support member 11.

The slide member 15 has an approximately box shape in which one end surface is open. The slide member 15 has a size to accommodate the spring member 16 therein and to be accommodated in the interior of the pivotal support member 12. The slide member 15 is slidably provided in the interior of the pivotal support member 12 to face its open surface upward when the document holder 20 is in the closed position. A distal end 151 of the slide member 15 (a lower end thereof in the closed position of the document holder 20) is formed to allow one side 151A thereof extending in the right-to-left direction to always abut on the surface 111A of the surface plate 111 of the stationary support member 11 while the pivotal support member 12 pivotally moves with the slide member 15 disposed in the interior of the pivotal support member 12.

The spring member 16 is formed of, for example, a coiled spring. The spring member 16 is accommodated in the interior of the slide member 15. The spring member 16 has a length with which it can bias the slide member 15 toward moving the slide member 15 close to the stationary support member 11 by being always compressed by a constituent surface of the distal end 151 of the slide member 15 and the top plate of the stationary support member 12 while the document holder 20 pivotally moves between its closed position and open position. However, so long as the spring member 16 can always bias the slide member 15 toward moving the slide member 15 close to the stationary support member 11, it may have any known arbitrary structure.

The pivotal shaft 13 has a columnar shape. The pivotal shaft 13 has a length larger than the length of the surface plate 111 of the stationary support member 11 in the widthwise direction and substantially equal to the length of the front plate 121 of the pivotal support member 12 in the widthwise direction. The pivotal shaft 13 is passed through the through holes 113 in the pair of side plates 112 of the stationary support member 11 and then attached to the pair of side plates 123 of the pivotal support member 12. Thus, the pivotal support member 12 can pivotally move with and about the axis of the pivotal shaft 13 with respect to the stationary support member 11 and, as a result, the document holder 20 pivotally moves between its closed position and its open position.

The grease sweeper 14 is a tool that sweeps grease applied to the surface 111A of the surface plate 111 of the stationary support member 11. The grease sweeper 14 is formed of a resin member having a plate-like shape and having elasticity. The grease sweeper 14 has a length substantially equal to the length of the surface plate 111 of the stationary support member 11 in the widthwise direction.

The grease sweeper 14 is attached to the pivotal support member 12, specifically to a front end 152 of the distal end surface 151 of the slide member 15. In doing so, the attachment of the grease sweeper 14 is made to allow a distal end 141 of the grease sweeper 14 (an end thereof on the side opposite to the side thereof where the grease sweeper 14 is attached to the slide member 15) to always abut on the surface 111A of the surface plate 111 of the stationary support member 11 by the elastic force of the grease sweeper 14 while the pivotal support member 12 pivotally moves. Thus, a space A accommodating grease G is formed by the distal end 141 of the grease sweeper 14, the distal end 151 of the slide member 15, and the surface 111A of the stationary support member 11.

The hinge device 10 is assembled in the following manner. Specifically, the slide member 15 and the grease sweeper 14 are positioned to allow the grease G applied to the surface 111A of the stationary support member 11 to be accommodated in the space A between the grease sweeper 14 located closer to the front of the body 2 and the one side 151A of the distal end 151 of the slide member 15 located rearward of the grease sweeper 14 and abutting on the stationary support member 11. In this state, the pivotal shaft 13 is passed through the through holes 113 in the side plates 112 of the stationary support member 11, the pivotal support member 12 is disposed to cover the slide member 15 and the stationary support member 11, and the pivotal shaft 13 is attached to the side plates 123 of the pivotal support member 12. The hinge device 10 assembled in this manner is made of, for example, a resin material.

Next, a description will be given of the operations of the hinge device 10 and the grease sweeper 14.

First, when the document holder 20 is in the closed position where it covers the top surface of the body 2 of the image forming apparatus 1, i.e., the position shown in FIG. 4, grease G is accommodated in the space A enclosed by the distal end 141 of the grease sweeper 14, the distal end 151 of the slide member 15, and the surface 111A of the stationary support member 11.

When the document holder 20 pivotally moves with and about the axis of the pivotal shaft 13 to the open position where it opens the top surface of the body 2 of the image forming apparatus 1, i.e., the position shown in FIG. 5, the grease sweeper 14 located frontward of the grease G and always abutting on the surface 111A of the stationary support member 11 moves while sweeping the surface 111A of the stationary support member 11. Thus, the grease G on a portion of the surface 111A of the stationary support member 11 exposed by opening the document holder 20 is wiped with the grease sweeper 14.

Thereafter, when the document holder 20 pivotally moves with and about the axis of the pivotal shaft 13 back to the closed position where it covers the top surface of the body 2 of the image forming apparatus 1, i.e., the position shown in FIG. 4, the slide member 15 is moved in the interior of the pivotal support member 12 in the direction toward the stationary support member 11 by the biasing force of the spring member 16. Thus, the distal end 151 of the slide member 15 always abuts on the surface 111A of the stationary support member 11 while being located rearward of the grease sweeper 14 and, as a result, the grease G is applied again to the surface 111A of the stationary support member 11 by the distal end 151 of the slide member 15.

In this manner, the grease G moves on the surface 111A of the stationary support member 11 as it is accommodated in the space A, and it is repeatedly wiped and applied again on the surface 111A each time the pivotal support member 12 pivotally moves with respect to the stationary support member 11.

Meanwhile, also in the general hinge element described previously, in order to achieve smooth opening and closing of the document conveying device, grease need to be applied to the surface of the stationary support frame on which the pivotal support frame slides. Generally, when the document conveying device is opened, the surface of the stationary support frame is exposed at a position where the original document which is used in the image forming apparatus and the user using the image forming apparatus can touch the surface. At this time, there arise a problem that because the grease adheres to the surface of the stationary support frame, the original document and the user may touch the grease and become stained with it.

Unlike the above, the hinge device 10 according to this embodiment includes the grease sweeper 14 abutting on the surface 111A of the stationary support member 11. With the operation of opening the document holder 20, the grease sweeper 14 wipes grease G applied to the surface 111A of the stationary support member 11. Thus, the grease G is not left on a portion of the surface 111A of the stationary support member 11 exposed by opening the document holder 20 and, therefore, the original document and the user can be prevented from touching the grease G applied to the surface of the hinge device 10.

Furthermore, in the hinge device 10 according to this embodiment, the pivotal support member 12 includes the slide member 15 and one side 151A of the distal end 151 of the slide member 15 abuts, at the rear of the grease sweeper 14, on the surface 111A of the stationary support member 11. Thus, with the operation of closing the document holder 20, the grease G wiped with the grease sweeper 14 and accommodated in the space A between the distal end 141 of the grease sweeper 14 and the distal end 151 of the slide member 15 can be spread and applied again onto the surface 111A of the stationary support member 11 by the distal end 151 of the slide member 15. Hence, it can be prevented that the hinge device 10 runs out of the grease G and becomes hard to operate.

The description of the embodiment of the present disclosure has so far been given with reference to the drawings. However, the present disclosure is not limited to the above embodiment and can be implemented in various forms without departing from the gist of the present disclosure. The various formations of the disclosure can be made by appropriately combining a plurality of components disclosed in the above embodiment. For example, some of all the components disclosed in the above embodiment may be deleted. For the sake of ease of understanding, the drawings may be schematic representation, primarily of components. The number of components and so on shown in the drawings may be different from those of actual components for convenience of creation of the drawings. The components described in the above embodiment are merely illustrative, not particularly limited, and can be changed variously without substantially departing from the effects of the present disclosure.

For example, although in the above embodiment the pivotal support member 12 includes the slide member 15 and the spring member 16, the present disclosure is not limited to this. For example, the pivotal support member 12 may have a structure not including the slide member 15 and the spring member 16. In this case, the grease sweeper 14 is attached directly to the pivotal support member 12. Alternatively, the pivotal support member 12 may include, instead of the slide member 15, an abutment member which is provided fixedly on the pivotal support member 12 and always abuts, at the rear of the grease sweeper 14, on the stationary support member 11 while the pivotal support member 12 pivotally moves with respect to the stationary support member 11.

### INDUSTRIAL APPLICABILITY

The present disclosure is applicable to the fields of hinge devices and image forming apparatuses.

What is claimed is:

1. A hinge device supporting a document holder to allow the document holder to open and close with respect to a body of an image forming apparatus, the hinge device comprising:
a stationary support member provided on the body of the image forming apparatus;
a pivotal support member provided on the document holder and pivotally connected through a pivotal shaft to the stationary support member; and
a grease sweeper attached to the pivotal support member,
a distal end of the grease sweeper always abutting on a surface of the stationary support member while the pivotal support member pivotally moves.

2. The hinge device according to claim 1, wherein
the pivotal support member comprises: a slide member capable of sliding toward and away from the stationary support member; and a spring member that biases the slide member toward moving the slide member close to the stationary support member,
a distal end of the slide member always abuts on the surface of the stationary support member by a biasing force of the spring member while the pivotal support member pivotally moves,
the stationary support member is provided at a rear end of the body of the image forming apparatus, and
the grease sweeper is attached to a front end of the slide member.

3. The hinge device according to claim 2, wherein one side of the distal end of the slide member abuts, at a rear of the grease sweeper, on the surface of the stationary support member.

4. An image forming apparatus comprising:
the hinge device according to claim 1; and
an image forming device that forms an image on a sheet.
